(19) United States
(12) Patent Application Publication
(10) Pub. No.: US 2020/0273368 A1
(43) Pub. Date: Aug. 27, 2020

(54) Kicking Training Apparatus

(71) Applicant: Jae Do CHOI, Ansan-si (KR)

(72) Inventor: Jae Do CHOI, Ansan-si (KR)

(21) Appl. No.: 16/799,979

(22) Filed: Feb. 25, 2020

(30) Foreign Application Priority Data
Feb. 26, 2019 (KR) 10-2019-0022172

(51) Int. Cl. G09B 19/00; A63B 69/00; A63B 1/00

(52) U.S. Cl. CPC G09B 19/0038; A63B 1/00; A63B 69/004

(57) ABSTRACT

Disclosed is a kicking training apparatus for allowing a user to practice accurately and effectively a kicking posture through gradual and systematic training, without bringing about body pain, when the user practices kick training, such as front kick or side kick, in exercise or martial arts including taekwondo. The kicking training apparatus includes a stationary frame which is fixed to a floor or a wall; a kicking training member with one end being rotatably engaged to an upper end of the stationary frame; and an angle adjusting member with one end being rotatably engaged to a lower end of the kicking training member, and the other end being able to move in a longitudinal direction of the stationary frame and being fixed to a desired position to adjust an angle of the kicking training member with respect to an upper end of the kicking training member.

### CROSS REFERENCE TO RELATED APPLICATION

This application claims priority from Korean Patent Application No. 10-2019-0022172, filed on Feb. 26, 2019, which is hereby incorporated by reference for all purposes as if fully set forth therein.

### BACKGROUND OF THE INVENTION

### Field of the Invention

The present invention relates to a kicking training device, and more particularly, to a kicking training apparatus for allowing a user to practice accurately and effectively a kicking posture through gradual and systematic training, without bringing about body pain, when the user practices kick training, such as front kick or side kick, in exercise or martial arts including taekwondo.

### Background of the Related Art

In exercise or martial arts, such as taekwondo, Taekkyon, Jit-Jitsu, trainees generally practice punching skills and kicking skills by various punching and kicking training devices. Accordingly, various punching and kicking apparatus has been proposed to allow a user to personally practice punching and kicking.

As one example of the conventional punching and kicking apparatus, there is a kick pad, in which an instructor or a director hold a kick pad with a hand to set a kick position. Accordingly, various apparatus for practicing the kicking training has been proposed.

One example of the punching and kicking apparatus is disclosed in Korean Utility Model No. 20-0197050, entitled “Martial arts training apparatus with adjustable punch bag”, in which two hinges are engaged to one end of a rod with a cushion bag attached to the other end of the rod, and the rod is fixed to a vertical shaft in a state in which a height, length and position of the cushion bag is variably selected.

However, the punching and kicking apparatus of the related art has the following problem. When a user hits the cushion bag, the cushion bag is not returned to its original position. In order to practice more punching and kicking training, the user should return the cushion bag to the original position by himself every time. Therefore, the user cannot continuously practice the punching and kicking practice, and the height of the rod should be frequently changed according to multiple hitting points of the punching and kicking training.

Another example is disclosed in Korean Unexamined Patent Publication No. 10-2001-0105459, entitled “Punching training apparatus”, in which a user can punch a 3D model of a human body to practice various punching skill required for actual boxing, thereby solving a problem involved in the conventional apparatus in that a user can practice straight punching training on a punching bag protruding from a 2D planar model.

The punching training apparatus of the patent has some problems in that a wide space is occupied by the model of the human body to increase a manufacturing cost, and it is easily broken by strong hitting, such as kicking.

Another example is disclosed in Korean Utility Model No. 20-1999-0022787, entitled “Target for training martial arts”, in which if a user hits the target by a hand or a foot, the target is bent to absorb the applied impact. The target includes a core made of sponge to elastically and evenly absorb the impact, without being broken, and an upholstery made of artificial leather or similar material to enclose the core. A plurality of cores having the same thickness are overlapped with each other.

The above target has a problem in that the target is configured to be elastically bent by the hitting to alleviate the impact, but the elasticity is gradually decreased by the strong or repeated hitting, so that the performance is deteriorated.

Also, further another example is disclosed in Korean Unexamined Utility Model Publication No. 20-1998-0014292, entitled “Apparatus for training martial arts”. The apparatus includes a rectangular hollow column having a lifting unit for installing the column between a ceiling and a floor according to a height of an installation spot, an adjusting member which is able to vertically slide along an outer surface of the column to adjust the height of a target mitt, a fixing member for adjusting and fixing the adjusting unit at a desired position, a fastening member for fastening a coupling bar mounted with the target mitt to a side of the adjusting member, and a damping member for absorbing the impact applied from the target mitt, the coupling bar and the adjusting member when the components are installed to the column to adjust the height of the target mitt.

In the case where the target mitt is applied by the strong impact, the target mitt is likely to be broken or bent by the strong force. In particular, the durability is decreased by the repeated punching and kicking training, and thus the lifetime becomes short, thereby increasing the maintenance cost.

Among worldwide martial arts, taekwondo is in possession of matchless skills in the filed of kicking. Nevertheless, it is difficult to find deep theory for the kicking, and the repetitive motion is considered as the best training method.

Therefore, the training method for trainees of general martial arts schools should include a theory and a gradual training step for kicking. If not, if the trainee practices the kicking motion by force, the trainee may suffer damaged to cruciate ligament of his or her knee or damaged to his or her ankle.

### PATENT LITERATURES

Patent Document 1: Korean Utility Model No. 20-0197050 (published on Sep. 15, 2000)

Patent Document 2: Korean Unexamined Patent Publication No. 10-2001-0105459 (published on Nov. 29, 2001)

Patent Document 3: Korean Utility Model No. 20-1999-0022787 (published on Jul. 5, 1999)

Patent Document 4: Korean Unexamined Utility Model Publication No. 20-1998-0014292 (published on Jun. 5, 1998)

Patent Document 5: Korean Unexamined Utility Model Publication No. 20-2011-0003939 (published on Apr. 21, 2011)

### SUMMARY OF THE INVENTION

Therefore, the present invention has been made in view of the above problems, and an object of the invention is to provide a kicking training apparatus for allowing a user to practice accurately and effectively a kicking posture through gradual and systematic training, without bringing about body pain, when the user practices kick training, such as front kick or side kick, in exercise or martial arts including taekwondo.

In order to achieve the above object, according to one aspect of the invention, there is provided a kicking training apparatus including: a stationary frame which is fixed to a floor or a wall; a kicking training member with one end being rotatably engaged to an upper end of the stationary frame; and an angle adjusting member with one end being rotatably engaged to a lower end of the kicking training member, and the other end being able to move in a longitudinal direction of the stationary frame and being fixed to a desired position to adjust an angle of the kicking training member with respect to an upper end of the kicking training member.

The stationary frame includes a pair of vertical bars and a plurality of horizontal bars installed at plural positions between the pair of vertical bars.

The kicking training apparatus further includes a fixing member for fixing at least one of the vertical bars and the horizontal bars; and strap holders provided to the pair of vertical bars, respectively, so that the user training a kicking posture can hold the strap holders by hands.

The kicking training member includes a pivot bar with one end being engaged to the horizontal bar which is the upper end of the stationary frame, the pivot bar being able to rotate around a pivot shaft, a roller support extending from the pivot bar in a longitudinal direction, and a plurality of roller members with both ends being rotatably engaged to the roller support, the roller members being arranged in a longitudinal direction of the roller support.

The kicking training member may include a pivot bar with one end being engaged to the horizontal bar which is the upper end of the stationary frame, the pivot bar being able to rotate around a pivot shaft, and a plurality of roller members with both ends being rotatably engaged to the pivot bar, the roller members being arranged in a longitudinal direction of the pivot bar.

The angle adjusting member includes a movable bar with both ends being slidably engaged to the pair of vertical bars 110, respectively, retainers provided to the movable bar to fix the movable bar to the vertical bars in a state in which the movable bars are moved to a desired position along the vertical bars, and a pair of angle adjusting bars with one end being rotatably engaged to the movable bar and the other end being engaged to both side sides of the lower end of the pivot bars and being able to rotate around a rotational shaft.

The angle adjusting member may include a pair of angle adjusting bars with each end being slidably engaged to the vertical bar, and a movable bar for fixing the angle adjusting bars to the vertical bars at a given position.

With the above configuration of the kicking training apparatus according to the invention, a user can practice accurately and effectively a kicking posture through gradual and systematic training, without bringing about body pain, when the user practices kick training, such as front kick or side kick, in exercise or martial arts, such as taekwondo, Taekkyon, and Jit-Jitsu.

These and other features, aspects and advantages of the present invention will become better understood with reference to the following description and appended claims.

### BRIEF DESCRIPTION OF THE DRAWINGS

Reference is now made briefly to the accompanying drawings, in which:

FIG. 1 is a perspective view illustrating a kicking training apparatus according to one embodiment of the invention in a state in which a kicking training member stands up;

FIG. 2 is a front view illustrating the kicking training apparatus according to one embodiment of the invention in the state in which a kicking training member stands up;

FIGS. 3 to 5 are perspective views illustrating the kicking training apparatus according to one embodiment of the invention in a state in which the kicking training member is adjusted at a given angle;

FIG. 6 is a perspective view illustrating an upper portion of the kicking training apparatus according to one embodiment of the invention;

FIG. 7 is a perspective view illustrating a lower portion of the kicking training apparatus according to one embodiment of the invention;

FIG. 8 is a perspective view illustrating a portion of an angle adjusting member of the kicking training apparatus according to one embodiment of the invention;

FIGS. 9 and 10 are pictures showing examples of front kicking motions by use of the kicking training apparatus according to one embodiment of the invention; and

FIGS. 11 and 12 are pictures showing examples of side kicking motions by use of the kicking training apparatus according to one embodiment of the invention.

### DETAILED DESCRIPTION OF THE PREFERRED EMBODIMENT

The above and other objects and advantages will be readily apparent to those skilled in the art from the detailed description and the accompanying drawings.

Hereinafter, embodiments of the present invention will be explained in detail with reference to the accompanying drawings. The above described embodiments of the present invention are intended to be illustrative only. Numerous alternative embodiments may be devised by those skilled in the art without departing from the scope of the following claims.

Unless the context indicates otherwise, it will be further understood that the terms “comprising” and/or “including” when used in this specification, specify the presence of stated features, integers, steps, operations, elements, and/or components, but do not preclude the presence or addition of one or more other features, integers, steps, operations, elements, components, parts or combination thereof.

Now, a kicking training apparatus according to one embodiment of the invention will be described in detail with reference to the accompanying drawings.

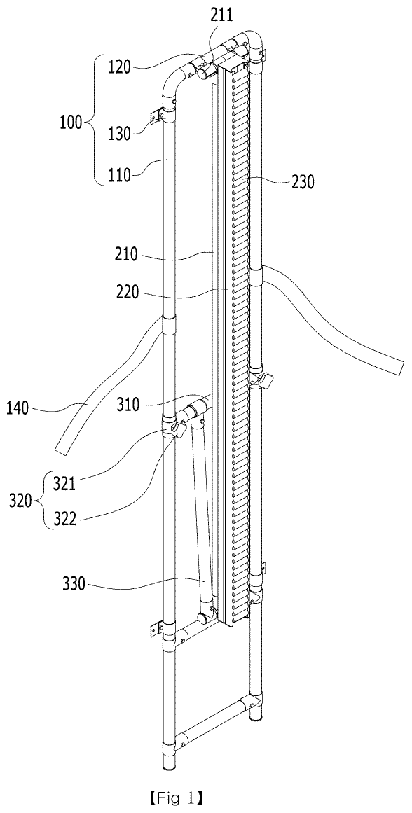

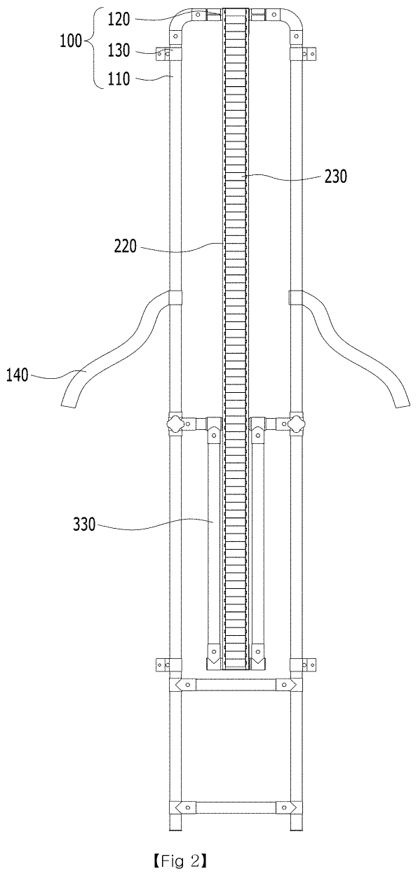

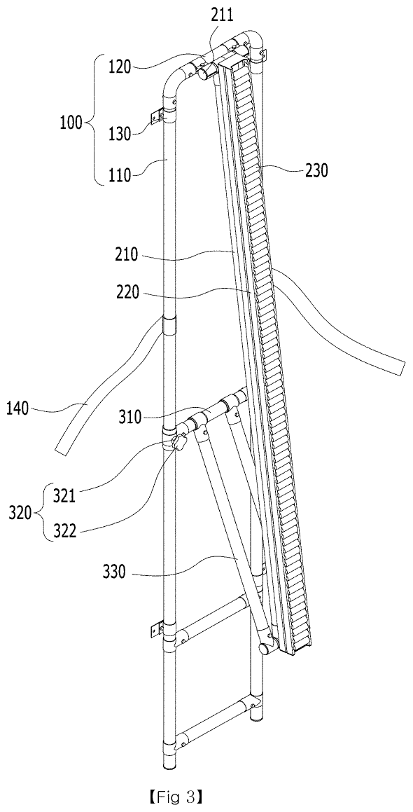

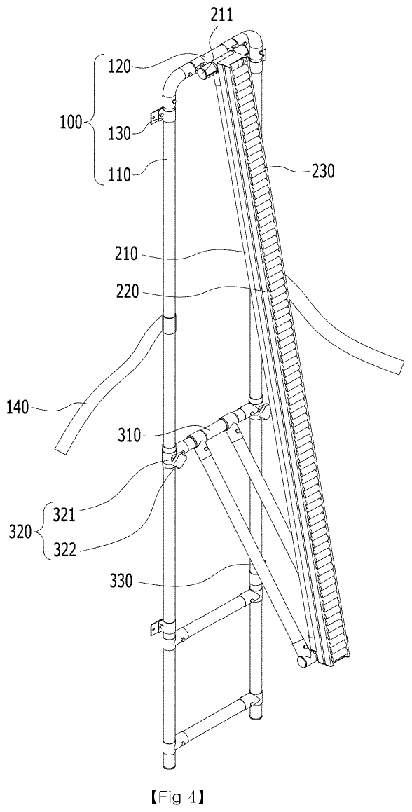

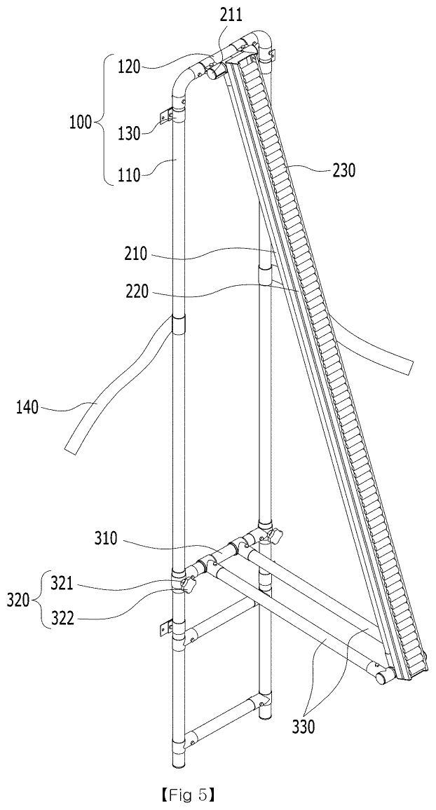

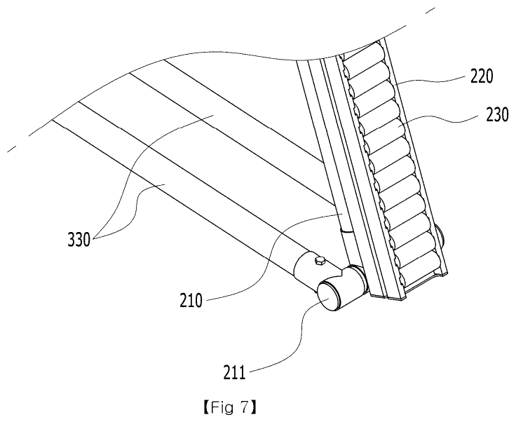

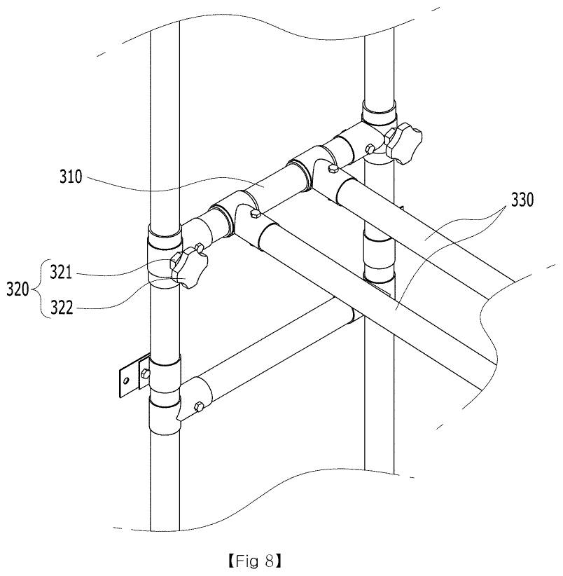

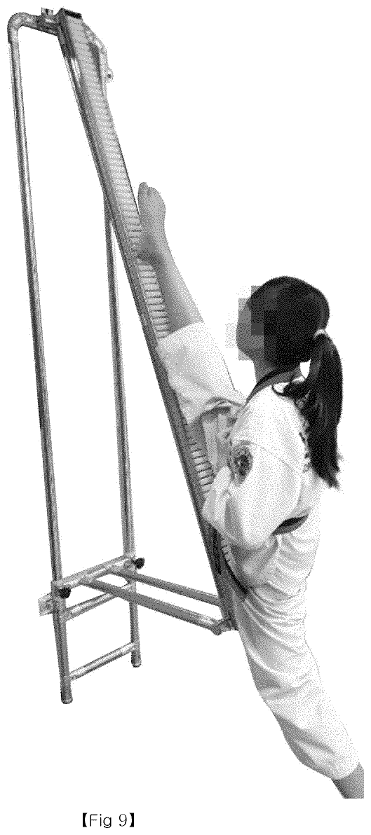

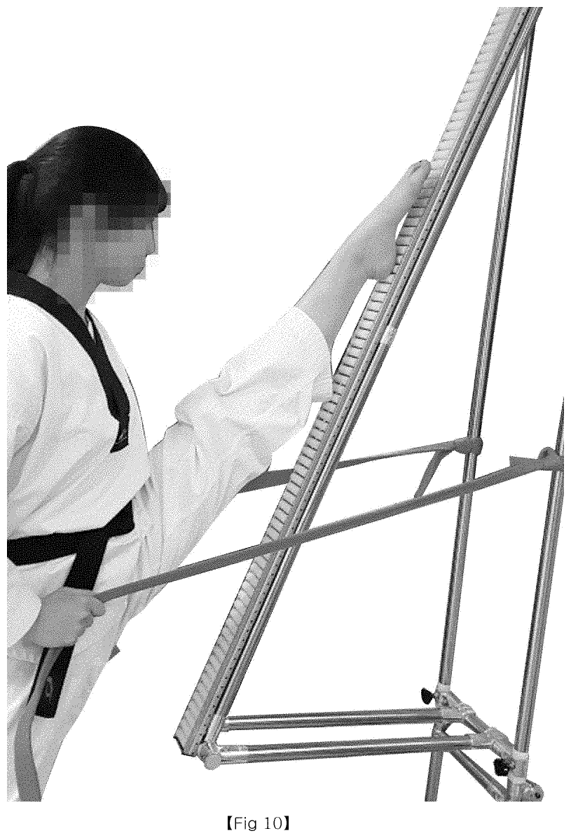

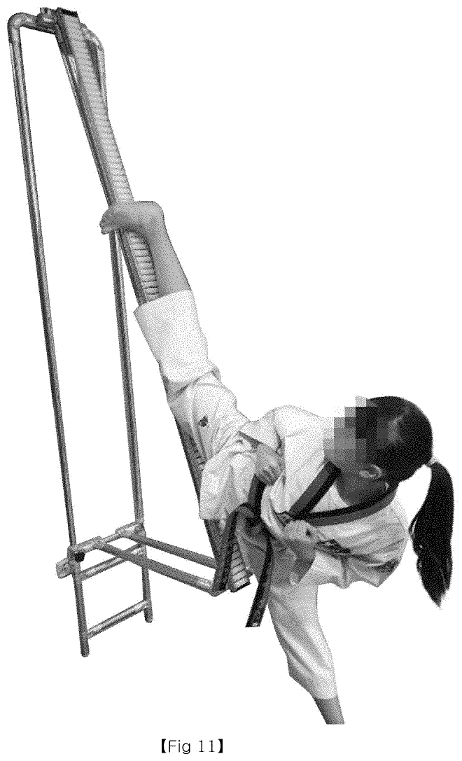

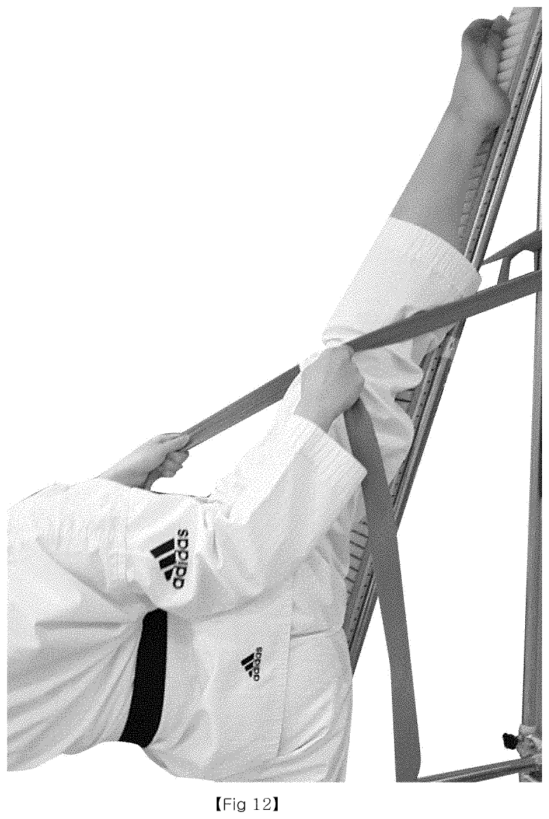

FIG. 1 is a perspective view illustrating a kicking training apparatus according to one embodiment of the invention in a state in which a kicking training member stands up. FIG. 2 is a front view illustrating the kicking training apparatus according to one embodiment of the invention in the state in which a kicking training member stands up. FIGS. 3 to 5 are perspective views illustrating the kicking training apparatus according to one embodiment of the invention in a state in which the kicking training member is adjusted at a given angle. FIG. is a perspective view illustrating an upper portion of the kicking training apparatus according to one embodiment of the invention. FIG. 7 is a perspective view illustrating a lower portion of the kicking training apparatus according to one embodiment of the invention. FIG. 8 is a perspective view illustrating a portion of an angle adjusting member of the kicking training apparatus according to one embodiment of the invention. FIGS. 9 and 10 are pictures showing examples of front kicking motions by use of the kicking training apparatus according to one embodiment of the invention. And, FIGS. 11 and 12 are pictures showing examples of side kicking motions by use of the kicking training apparatus according to one embodiment of the invention.

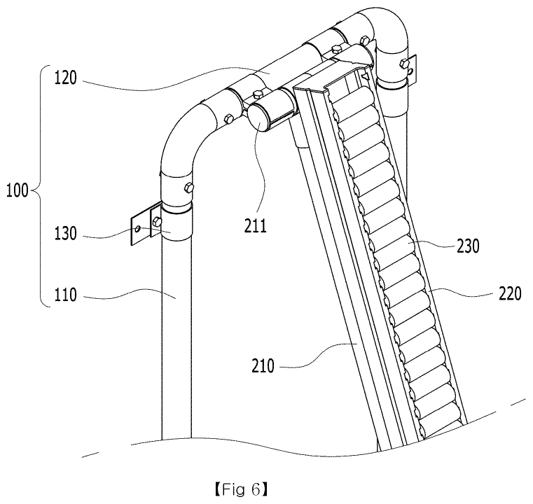

The kicking training apparatus includes, as illustrated in FIGS. 1 to 12, a stationary frame 100 fixed to a floor or a wall; a kicking training member with one end being rotatably engaged to an upper end of the stationary frame 100; and an angle adjusting member with one end being rotatably engaged to a lower end of the kicking training member, and the other end being able to move in a longitudinal direction of the stationary frame 100 and being fixed to a desired position to adjust an angle of the kicking training member with respect to an upper end of the kicking training member.

The stationary frame 100 includes a pair of vertical bars 110, a plurality of horizontal bars 120 installed at plural positions between the pair of vertical bars 110, and a plurality of fixing members 130 for fixing the vertical bars 110 and/or the horizontal bars 120 to a wall, as illustrated in the drawings.

The horizontal bars 120 generally form an upper end and a lower end of the vertical bars 110.

The fixing member 130 is not limited to special means for firmly fixing the vertical bars 110 and/or the horizontal bars 120, and may include a C-shaped or U-shaped clip for enclosing the bars 110 and 120 or a screw for fixing the bars, for example.

The stationary frame 100 is engaged with the kicking training member and the angle adjusting member, and is not limited to a special type to be fixed to the floor or the wall.

In other words, the stationary frame 100 consists of a plurality of bars so that the frame can be maintained and fixed by its own configuration, without using a separate fixing member.

The kicking training apparatus according to the invention may further include strap holders 140 provided to the pair of vertical bars 110, respectively, and the user training a kicking posture can hold the strap holders by hands (see FIGS. 10 and 12).

Now, the configuration of the kicking training member rotatably engaged to the upper end of the stationary frame 100 will be described.

The kicking training member includes a pivot bar 210 with one end being engaged to the horizontal bar 120 which is the upper end of the stationary frame 110, the pivot bar being able to rotate around a pivot shaft 211, a roller support 220 extending from the pivot bar 210 in a longitudinal direction, and a plurality of roller members 230 with both ends being rotatably engaged to the roller support 220, the roller members being arranged in a longitudinal direction of the roller support 220.

In the kicking training member, the pivot bar 210 may be formed integrally with the roller support 220. In other words, the plurality of the roller members 230 may be engaged to the pivot bar 210, instead of the roller support 220.

When the user practices the front kicking posture, as shown in FIGS. 9 and 10, or the side kicking posture, as shown in FIGS. 11 and 12, the kicking training member allows a sole or an inside of a foot to smoothly move along the roller members 230.

The angle of the roller members 230 can be adjusted by the angle adjusting member, which will be described later, at the kicking training, so that the user can practice the kicking posture while changing the angle of the kicking posture.

The angle adjusting member of the kicking training member according to the embodiment includes a movable bar 310 with both ends being slidably engaged to the pair of vertical bars 110, respectively, retainers 320, each provided to the movable bar 310, for fixing the movable bar 310 to the vertical bars 110 in a state in which the movable bars are moved by a desired position along the vertical bars 110, and a pair of angle adjusting bars 330 with one end being rotatably engaged to the movable bar 310 and the other end being engaged to both side sides of the lower end of the pivot bars 210 and being able to rotate around a rotational shaft 331, as illustrated in the drawings.

If the retainer 320 is loosen, the movable bar 310 can smoothly move along the vertical bars 110. If the retainer 320 is tightened, the movable bar 310 can be firmly fixed to the vertical bars 110. The invention is not limited to a specific configuration of the retainer 320.

For example, as illustrated in the drawings, the retainer 320 has a bolt 322 with a knob which is threadedly engaged to a threaded hole formed in a cylindrical coupler 321. The cylindrical coupler 321 is provided at both ends of the movable bar 310, and is engaged to the vertical bars 110 to move along the vertical bars.

Alternatively, the angle adjusting member may not include the movable bar 310. In other words, one end of the respective angle adjusting bars 330 is slidably engaged to the vertical frame 110, and the angle adjusting bars 330 are fixed by the retainers 320 at the given position.

In this instance, one end of the respective angle adjusting bars 330 may be hinged to the cylindrical coupler which is slid along the vertical bar 110. The cylindrical coupler is provided with a threaded hole, and the bolt of the retainer 320 is threadedly engaged to the threaded hole.

Preferably, engineering plastic for smooth rotation and smooth sliding movement is provided between rotatably engaging components and within the cylindrical coupler.

The kicking training apparatus according to this embodiment can allow the user to practice the kicking posture by adjusting the angle of the kicking training member with the angle adjusting member.

With the above configuration of the kicking training apparatus according to this embodiment, allowing a user to practice accurately and effectively the kicking posture through gradual and systematic training, without bringing about body pain, when the user practices kick training, such as front kick or side kick, in exercise or martial arts, such as taekwondo, Taekkyon, and Jit-Jitsu.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A kicking training apparatus comprising:
a stationary frame which is fixed to a floor or a wall;
a kicking training member with one end being rotatably engaged to an upper end of the stationary frame; and
an angle adjusting member with one end being rotatably engaged to a lower end of the kicking training member, and the other end being able to move in a longitudinal direction of the stationary frame and being fixed to a desired position to adjust an angle of the kicking training member with respect to an upper end of the kicking training member.

2. The kicking training apparatus according to claim 1, wherein the stationary frame includes a pair of vertical bars and a plurality of horizontal bars installed at plural positions between the pair of vertical bars.

3. The kicking training apparatus according to claim 1, further comprising:
a fixing member for fixing at least one of the vertical bars and the horizontal bars; and
strap holders provided to the pair of vertical bars, respectively, so that the user training a kicking posture can hold the strap holders by hands.

4. The kicking training apparatus according to claim 1, wherein the kicking training member includes
a pivot bar with one end being engaged to the horizontal bar which is the upper end of the stationary frame, the pivot bar being able to rotate around a pivot shaft,
a roller support extending from the pivot bar in a longitudinal direction, and
a plurality of roller members with both ends being rotatably engaged to the roller support, the roller members being arranged in a longitudinal direction of the roller support.

5. The kicking training apparatus according to claim 1, wherein the kicking training member includes
a pivot bar with one end being engaged to the horizontal bar which is the upper end of the stationary frame, the pivot bar being able to rotate around a pivot shaft, and
a plurality of roller members with both ends being rotatably engaged to the pivot bar, the roller members being arranged in a longitudinal direction of the pivot bar.

6. The kicking training apparatus according to claim 4, wherein the angle adjusting member includes
a movable bar with both ends being slidably engaged to the pair of vertical bars 110, respectively,
retainers provided to the movable bar to fix the movable bar to the vertical bars in a state in which the movable bars are moved to a desired position along the vertical bars, and
a pair of angle adjusting bars with one end being rotatably engaged to the movable bar and the other end being engaged to both side sides of the lower end of the pivot bars and being able to rotate around a rotational shaft.

7. The kicking training apparatus according to claim 4, wherein the angle adjusting member includes
a pair of angle adjusting bars with each end being slidably engaged to the vertical bar, and
a movable bar for fixing the angle adjusting bars to the vertical bars at a given position.

8. The kicking training apparatus according to claim 5, wherein the angle adjusting member includes
a movable bar with both ends being slidably engaged to the pair of vertical bars 110, respectively,
retainers provided to the movable bar to fix the movable bar to the vertical bars in a state in which the movable bars are moved to a desired position along the vertical bars, and
a pair of angle adjusting bars with one end being rotatably engaged to the movable bar and the other end being engaged to both side sides of the lower end of the pivot bars and being able to rotate around a rotational shaft.

9. The kicking training apparatus according to claim 5, wherein the angle adjusting member includes
a pair of angle adjusting bars with each end being slidably engaged to the vertical bar, and
a movable bar for fixing the angle adjusting bars to the vertical bars at a given position.
